(19) United States
(12) Patent Application Publication
(10) Pub. No.: US 2003/0056812 A1
(43) Pub. Date: Mar. 27, 2003

(54) Method and apparatus for cleaning air handling systems

(75) Inventors: Robert G. Baker, Ruskin, FL (US); David Gonzalez, Apollo Beach, FL (US); Stephen Frazier, Lake Mary, FL (US)

Correspondence Address: BROWDY AND NEIMARK, P.L.L.C, 624 Ninth Street, N.W., Washington, DC, 20001, US

(73) Assignee: BBJ ENVIRONMENTAL SOLUTIONS, INC., Tampa, FL (US)

(21) Appl. No.: 10/046,560

(22) Filed: Jan. 16, 2002

Related U.S. Application Data
(60) Provisional application No. 60/298,093, filed on Jun. 15, 2001.

(51) Int. Cl. B08B 3/02

(52) U.S. Cl. 134/36; 134/34; 134/100.1

(57) ABSTRACT

An air handling system is equipped with a system for cleaning the air handling evaporator core in situ. Water is distributed through an intake manifold consisting of a plurality valve or other flow control device. Here, the water picks up treating agents, such as microbicides and cleaning agents. In one of the valves or other flow control devices, the water does not pick up a treating agent, and is used for rinsing. The treated or untreated water flows through a connector to an outlet manifold for contact with an evaporator core of an air handler.

### CROSS-REFERENCE TO RELATED APPLICATIONS

The present application claims priority from Ser. No. 60/298,093 filed Jun. 15, 2001, the entire contents of which are hereby incorporated by reference.

### FIELD OF THE INVENTION

The present invention relates to a method and apparatus for cleaning air handling systems such as air conditioners in situ.

### BACKGROUND OF THE INVENTION

Over time, air handling systems, such as air conditioners, can become contaminated by microbes, molds, and particulates from dust, dirt, cigarette smoke, and the like. When these systems are so contaminated, sanitation is compromised in the areas they service. The indoor environment deteriorates because disease-causing microbes are introduced thereto. Additionally, offensive odors may be introduced into the area. Finally, contamination buildup can cause operating efficiency to drop as much as 40%.

Akazawa, in U.S. Pat. No. 6,135,129, describes a cleaning method and apparatus for air intake passages in air conditioners. This comprises supplying a cleaning solvent and compressed air to the heat exchanger side from a special blowout port through an air intake passage, and means for moving cleaning and wiping elements in the air intake passage toward a specific blowout port side.

There exist a number of devices for cleaning the air in an air conditioning system. For example, Bachhofer et al., in U.S. Pat. No. 4,410,339, disclose an air washing apparatus having two separate cycling units. In the first unit, air is sprayed with a fluid consisting of water and a halogen to remove impurities from the air. The second cycling unit removes impurities which had been introduced into the fluid supply in the first unit. After treatment with ozone, the fluid is returned to the fluid supply where the halogen removes any ozone present.

Akazawa et al., in U.S. Pat. No. 5,911,742, disclose an attachment for an air conditioner which places at least one solvent discharge means in an air conditioning channel between air suction and air dispensing. The solvent discharge means includes a nozzle located between the upstream side of the heat exchanger and the downstream side of the fans.

Graham, U.S. Pat. No. 2,472,011, discloses an air treating apparatus for sterilizing air comprising an insulated vaporizer tank for a solution of water and glycol. A perforated steam supply pipe supplies dry steam to vaporize the liquid in the tank. Vapor leaves the tank through an outlet and is discharged directly into the inlet opening of the blower.

Cicirello, U.S. Pat. No. 3,576,593, discloses an environmental air sanitizer comprising means for withdrawing air from a room through a mechanical filter, dividing the air into two discrete paths, chemically treating the air in one path with a vapor phase additive, optically treating the air in the other path first with germicidal ultraviolet radiation followed by ozonizing ultraviolet radiation, mixing the two air streams, and returning the mixed air streams to the room.

None of the patents discussed above discloses or suggests a clean in place system for an air handling apparatus which operates while the air-handling device is automatically turned off. None of the patents discussed above discloses or suggests a method of controlling water dripping, scatter, overflow and distribution so nothing except the intended parts is exposed to the liquids being used.

### SUMMARY OF THE INVENTION

It is an object of the present invention to overcome the aforesaid deficiencies in the prior art.

It is another object of the present invention to provide a system for cleaning the heat exchange portion of an air-handling device in situ.

It is a further object of the present invention to provide a system for automatically cleaning an air handling system.

It is another object of the present invention to provide a system for cleaning and inhibiting growth on the cooling coil surfaces in an air handling system.

It is another object of the present invention to provide a system for cleaning and inhibiting growth on the cooling coil surfaces in an air handling system without wetting portions of the air-handler other than those intended to be cleaned and controlling foam so it does not overflow or otherwise exceed the capacity of the drain of the air-handler.

It is a further object of the present invention to treat heat exchange surfaces in an air handling system to prevent establishment of a biofilm.

According to the present invention, an air-handling device is equipped with a set of functional systems for cleaning the air handling evaporator coils in situ. These systems are comprised of the following general components:

1. Intake manifold and distribution valves/flow control

2. Mixing apparatus

3. Distribution manifold or injection nozzle

4. Distribution control system

Water or other fluid is distributed through the intake manifold through valves or other flow control devices (hereinafter valves), where the fluid in at least one valve collects treating agents, such as microbiostats, rinse aids, cleansers and other control compounds. The treated fluid then passes through a connection to distribution manifold(s), which empty onto the evaporator core of an air handler.

### BRIEF DESCRIPTION OF THE DRAWINGS

FIG. 1 shows a flow diagram for the cleaning system of the present invention attached to a typical air handling system.

FIG. 2 is an electrical diagram for the cleaning system of the present invention.

### DETAILED DESCRIPTION OF THE DRAWINGS

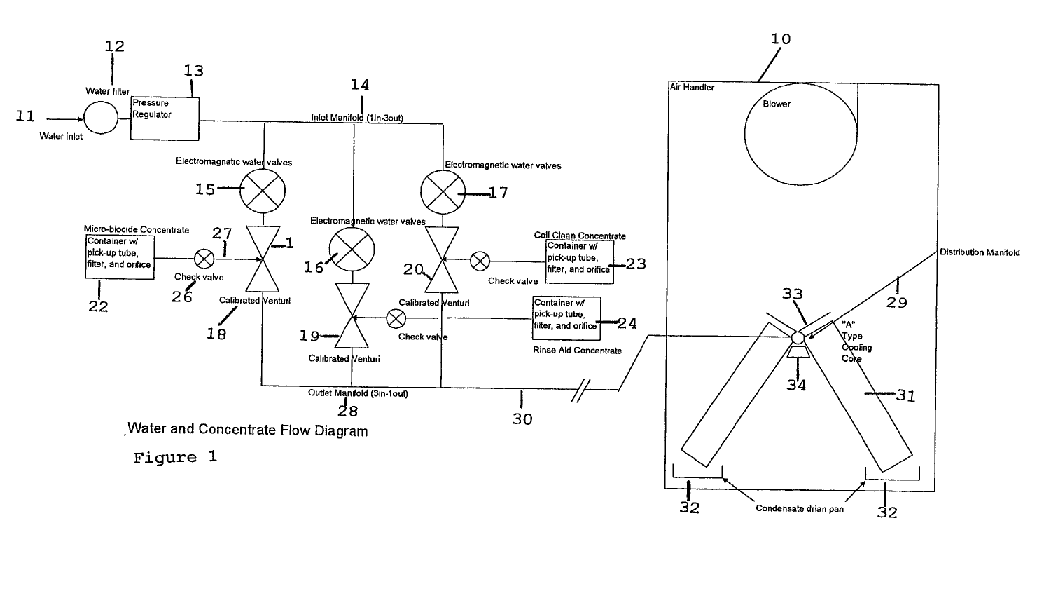

Referring to FIG. 1, a conventional air handler 10 is cleaned by means of the present invention. While the air handler 10 is typically part of an air-conditioning system, it can also be part of a forced-air heating system or the like. These systems, of course, can be used to condition or heat the air in, for example, buildings, ships, aircraft, automobiles, trains, or other areas in need thereof.

As mentioned above, the cleaning apparatus of the present invention is divided into the following four functional systems:

1. Intake manifold and distribution valves/flow control

2. Venturi or chemical dilution and mixing apparatus

3. Distribution manifold or injection nozzle

4. Distribution control system

Intake Manifold and Distribution Valves/Flow Control

Water or other suitable fluids (hereinafter water) are supplied through a supply inlet port 11 or other flow control device. Indeed, the present invention is adaptable to any type of water supply that will achieve the needed flow of at least 36 gph and pressure of 30 psi, including those actuated by electric, hydraulic, mechanical, or gravitational means. The water may originate from any source, although tap water provides the most convenient source. Water enters through a filter 12 and pressure/flow regulator 13 into an inlet manifold 14 (in this example, one inlet, three outlets). The filter 12 ensures that particle sizes in the supply water are sufficiently tiny to pass through the venturi and water distribution manifold without clogging. The pressure/flow regulator 13 guarantees that the clean in place system pressure is maintained at a constant pressure and flow (in this example, 30 psi). Maintaining this pressure also assures a constant mixing ratio between the water and the treating agents. In addition, this regulator causes flow to stop completely if water pressure falls below the level needed to assure adequate flow (30 psi). Further, consistent pressure assures proper dilution and distribution of the treatment agents to surfaces being treated without over spray, scattering, aerosolization, or other actions that would cause the water or treatment fluid to leak or cause wetting of adjacent surfaces.

The clean in place system does not necessarily require a distribution manifold or the capability of withstanding pressures of 60 psi. A gravity feed, for example, would only need to withstand pressures below 40 psi. Other suitable options for the system include electrical, hydraulic, or mechanical pumps or flow control devices that can provide adequate water and/or chemical flow therefrom.

Venturi or Chemical Mixing Apparatus

The water flows through the inlet manifold 14 and is distributed through one of three electromagnetic water valves 15, 16, 17. All of the valves, 15, 16 and 17, are each separately connected to an ASME standard venturi 18, 19, 20. These venturi 18, 19, 20 are calibrated to lower the 30 psi (or other) of the water pressure to approximately 15 psi at 36 gph, and to draw in the chemical treating agent (e.g., microbiocide) at a ratio of approximately 42 parts water to one part agent. Of course, these ratios are illustrative only, and will depend upon the chemicals employed by the system. Preferably, the pressure of the fluid as it flows through the venturi is lowered to approximately half of the initial pressure, so as to draw in the chemical treating agent. Both pressure and flow must be precisely controlled so as to achieve the correct dilution and mixing of the treatment fluid concentrates with water.) The check valves in the venturi stop backflow of fluid into the concentrate containers.

Optionally, the venturi may be replaced with another type of chemical mixing apparatus, such as pump, gravity, or mixing valves, or various types of flow restriction devices, such as long radius nozzles or thin-plate orifices.

For purposes of the present invention, a treating agent refers to any type of composition used to treat the air handling system. Non limiting examples include biocides, biostats, microbicides, detergents, rinse aids, antibacterials, antifungals, cleaners and deodorants.

Description of Dilution/Mixing

Water flowing through any one of the valves 15, 16, 17 is mixed with a treating agent which is stored in the associated containers 22, 23, 24. These containers can easily be replaced in toto as needed, or can be refilled with the appropriate chemical. In a preferred embodiment, the containers have a visual indicator of the level of the concentrate contained therein, to ensure that the customer is alerted when it is time to refill or replace the container of concentrate. This mixing takes place in the associated venturi 18, 19, 20. As the water flows through a venturi, the pressure is reduced by half. This causes a suction at the injection port which draws concentrated treatment fluid from the associated container 22, 23, or 24.

The injection port of the venturi has a check valve 26 and small diameter (here, approximately ⅛″) pick-up tube 27 attached and retained by a barred fitting. The other end of the pick-up tube 27 rests at the bottom of the associated container 22, 23, or 24 and has a filter/orifice assembly 25 which ensures that debris does not clog the check valve, the venturi injection port, or the spray nozzles and also meters the flow of the concentrate to the proper rate so as to achieve the desired dilution. The water and treating agent flow through the outlet manifold 28 to a connecting hose 30.

Distribution Manifold or Injection Nozzle

The outlet of each venturi 18, 19, 20 is then connected to an outlet manifold 28 which has three inlets and one outlet. The outlet manifold 28 is attached to a low-pressure, waterfall effect manifold 29 through a connecting hose 30 for distribution of the water/treating agent mixture. (Alternatively, the device may employ a spray nozzle assembly, rather than the low-pressure, waterfall effect manifold described below).

Distribution Manifold

The connecting hose 30 delivers the mixed water and concentrate, from the outlet manifold 28 to a distribution manifold assembly 29. The distribution manifold evenly delivers the rinse aid, treating agent, and cleaner solution onto the cooling coil 31. Excess water or solution flows into the condensate drain pan 32, from which it drains from the system. The flow of treatment solutions through the drain pan 32 also serves to clean the pan and associated drain line and treat those components so as to maintain these components free from growth and other contamination. The distribution manifold or spray nozzles are provided in a kit with very detailed instructions for installation. These instructions provide installation information as to how and where to place the distribution manifold based on the configuration of the core design, so that an effective fluid distribution, and therefore cooling coil saturation, is guaranteed.

The distribution manifold 29 is composed of a rigid non-metallic tubing (preferably poly carbonate) preferably about ⅜″ in diameter. The distribution manifold incorporates a series of precisely drilled holes that are spaced so as to achieve the proper flow and conform to the layout of the cooling coil. An important part of the manifold design involves reaming and deburring each hole so flow is uniform and unobstructed. The distribution manifold is attached to the cooling coil in such a way that a baffle plate 33 and wiper 34 contact the coil face so as to accurately direct and control the flow pattern of the treatment fluids. This assures a uniform and thorough wetting of all surfaces. The distribution manifold assembly is secured to the cooling coil shroud with supplied fastening hardware. Alternatively, mechanical means of attachment may also be provided when necessary. The retaining mechanism is constructed of materials that are compatible with the metals of the coil construction so as to avoid establishing a half-cell that would lead to corrosion and premature failure of the metallic components.

The cleaning system of the present invention can be made of any material resistant to the microbicides and cleaners utilized therein. Inert polymers are preferred sources of construction materials, although any cost-effective materials may be employed. The clean in place system may be enclosed in a box, which houses all components except the distribution manifold 29. The controller and actuator for the water valves are compatible with standard 24-volt a/c power supply normally available in residential air conditioning systems. Alternatively, other power sources may be utilized depending on the requirements of a particular instillation. Disablement of the air handling system and cycling on and off of the electromagnetic water valves as well as all other timing and control operations are controlled by a programmable logic circuit board.

Description of Control System

The cleaning system of the present invention can be controlled automatically. In one embodiment, a controller determines when the cleaning system needs to initiate a cleaning cycle by counting the number of times the air conditioner and blower are turned on for each air cooling cycle, and by sensing the minimum air conditioner load by monitoring outside air temperatures. Alternatively, the controller may sense total run time, elapsed time, reduced air flow or accumulation of contaminates on surfaces in the air handler or any combination of these factors and follow programmed logic to initiate a cleaning cycle. Additionally, the controller can establish a cycle time for the cleaning process so that cleaning takes place only at a predetermined optimal time. For example, heating and cooling loads are often minimal early in the morning hours such as at 3:00 AM. The time can be established so as to suit the preferences of the owner. In one embodiment, the unit cleans the air handler only in the early morning, when the cycle is less likely to inconvenience occupants of the building in which the air handler is located.

In another embodiment of the present invention, for use in hotels and the like, only the connecting hose and distribution manifold are located with the air handling unit. The control, water supply, and mixing unit are portable, such as carried on a cart that can be moved from room to room and plugged into each room unit to clean the cooling coils in each room's unit.

After a certain period of time, or following a certain number of cooling cycles, or upon satisfaction of some other condition, the controller disables the air handling system. For example, after approximately 2,000 cycles or three months, the system will wait until the 2,000 th cooling cycle has terminated and the outside air temperatures are within the desired range or after three months before disabling the air conditioner and activating the cleaning cycle of the clean in place system. The time or number of cycles between activation of the cleaning system may be set and adjusted according to the specific needs of the air handling system in which it operates.

After the air conditioner has been disabled, the clean in place system energizes the cleaning solution valve 15 which causes water to flow through its associated venturi 18, drawing cleaner concentrate from the container 22, mixing the two solutions and then routing the mixture through the connecting hose 30 to the distribution manifold 29, uniformly coating the cooling coil 31 with the dilute cleaner mixture. This will continue for the time needed to fully coat the coil (about 15-90 seconds, optimally 30 seconds). At the end of that time period, the control de-energizes the cleaning solution valve 15 and pauses for about 1 to 10 minutes (optimally about 4) so as to allow the solublizing and suspending action of the cleaning fluid to take place. At the end of the about 1 to 10 minute pause, the control energizes the rinse aid valve 16, sending water through its associated venturi 19, drawing rinse aid concentrate from container 23, mixing the two and delivering the mixture through the outlet manifold 28 to the connecting hose 30 and to the distribution manifold 29. Flow continues for about 1-5 minutes (optimally 2.5) in order to thoroughly rinse all soil/cleaner mixture from the cooling coil 31, into the drain pan 32 and out of the air-handler through a drain line. The rinse aid mixture also reduces all foam which otherwise would over flow the shallow drain pan 32 and lead to soiling and wetting of surfaces below the drain pan. At the end of the rinse time, the control de-energizes the rinse aid valve 16 and goes into pause mode for 30-90 seconds (optimally 60) in order for all fluid to drain from the cooling coil. Next, the control energizes the Microbiocide valve 17, sending water through the associated venturi 20, drawing microbiocide (or other treatment concentrate) from container 24, then delivering the mixture through outlet manifold 28 and connecting hose 30 to the distribution manifold 29. The treatment mixture flows from the distribution manifold 29 and uniformly is distributed over the surfaces of the cooling coil 31. The Microbiocide valve 17 remains energized for about 30 seconds to 3 minutes (optimally 1 minute) which provides sufficient flow of treatment fluid to both coat the cooling coil 31 and the drain pan 32 along with the drain line 33 with a treatment that will inhibit the growth of bacteria and fungi, including mold, until the next cleaning cycle. After the control de-energizes valve 17, it reenters the pause mode for about 7 to about 15 minutes in order to allow all excess fluid to drain from the air-handler and the treatment mixture to form an initial attachment to treated surfaces. At the end of the pause period, the heat exchanges surfaces are optionally treated to prevent establishment of a biofilm. When the cycle has completed, the control restores power to the air-handler and resets itself to timing mode in preparation for the next cleaning cycle. Once this is complete, the controller will reset its counters and wait until the requirements noted for activation of the clean in place system are satisfied before initiating another cleaning cycle.

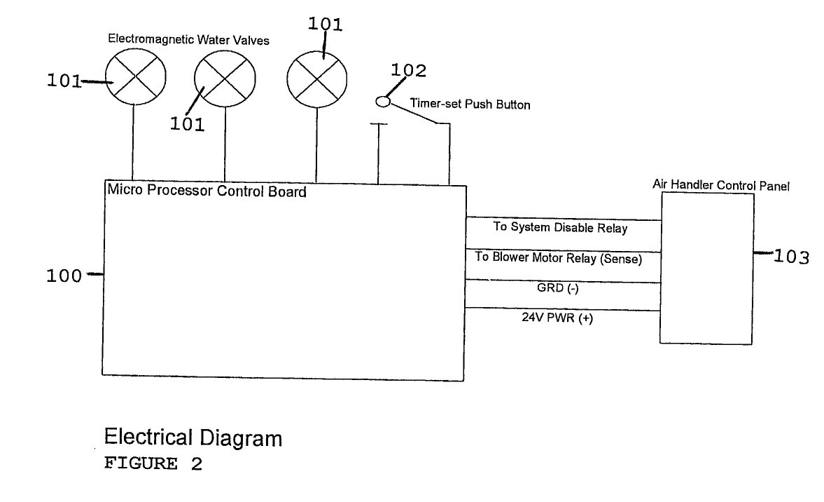

FIG. 2 illustrates the electrical control of the system of the present invention. A microprocessor control board controls three electromagnetic water valves 101 and a timer-set push button 102. This configuration is connected to an air handler control panel 103.

Of course, the system of the present invention may also be controlled manually. For example, instead of employing valves or other electrically actuated flow control devices, it is possible to substitute therefore various manually controlled valves. Additionally, automation of the proposed system may be achieved electrically (as with the PLC controller, above) or mechanically. This latter embodiment would entail the use of mechanical valves that, upon completing a specified number of rotations or cycles, engages the cleaning cycle of the device.

The foregoing description of the specific embodiments will so fully reveal the general nature of the invention that others can, by applying current knowledge, readily modify and/or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, parameters, and steps for carrying out various disclosed functions may take a variety of alternative forms without departing from. the invention.

Thus, the expressions, “means to . . . ” and “means for . . . ” or any method step language, as may be found in the specification above and/or in the claims below, followed by a functional statement, are intended to define and cover whatever structural, physical, chemical, or electrical element or structure, or whatever method step, which may now or in the future exist which carries out the recited functions, whether or not precisely equivalent to the embodiment or embodiments disclosed in the specification above, i.e., other means or steps for carrying out the same function can be used; and it is intended that such expressions be given their broadest interpretation.

What is claimed is:

1. A system for cleaning evaporator cores of an air handling system comprising:
a) an intake manifold;
b) flow control devices;
c) at least one container for treating agents;
e) an outlet manifold which connects to a connector;
f) a connector attached to fluid distributors which clean the evaporator core with water or solutions of water and treating agents.

2. The system according to claim 1 wherein the flow control device is selected from the group consisting of check valves, electrical flow control devices, mechanical flow control devices, hydraulic flow control devices, and combinations thereof.

3. The method according to claim 1 wherein the treating agents are selected from the group consisting of biocides, microbicides, microbiostats, disinfectants, rinse aids, cleaning agents, deodorants, and mixtures thereof.

4. The system according to claim 1 wherein the outlet manifold is selected from the group consisting of injection spray nozzles and low-pressure, waterfall-effect manifolds.

5. The system according to claim 1 wherein the pressure of water coming into the intake manifold is maintained at a predetermined pressure.

6. The system according to claim 5 wherein the pressure of water coming into the intake manifold is maintained at approximately 30 psi.

7. The system according to claim 1 wherein two of the check valves or other flow control devices are connected to one of the group consisting of venturi, pump valves, mixing valves, gravity valves, long radius nozzles, thin plate orifices, and flow restriction devices, in order to drop the water pressure to a lower pressure.

8. The system according to claim 7 wherein the water pressure is adjusted to about 15 psi.

9. The system according to claim 1 wherein the system is controlled automatically.

10. The system according to claim 1 wherein the system is controlled manually.

11. The system according to claim 1 wherein the at least one container for treating agents has a visual indicator of contents contained therein.

12. The system according to claim 1 wherein the outlet manifold and the connector are connected to the air handling unit and the remaining components are portable.

13. The system according to claim 1 further including a wiper associated with the distribution manifold that controls the flow of water and prevents drips and migration of water to other portions of the system.

14. The system according to claim 1 comprising three flow control devices.

15. A method for cleaning the evaporator core in an air handling system comprising:
a) introducing water into an intake port;
b) regulating the pressure of the water to a constant, predetermined value;
c) feeding the pressurized water through an intake manifold having at least one outlet to be distributed through at least one flow control device, at least one control device being are equipped with a device to reduce the water pressure and to draw in treating agents;
d) distributing the water and treating agents through an outlet manifold, through a connector, and to spray nozzles directed at the evaporator core whereby the water and treating agents clean, rinse, or disinfect the evaporator core.

16. The method according to claim 15 wherein the flow control device is selected from the group consisting of check valves, electrical flow control devices, mechanical flow control devices, hydraulic flow control devices, and combinations thereof.

17. The method according to claim 15 wherein the treating agents are selected from the group consisting of biocides, microbicides, cleaning agents, deodorants, and mixtures thereof.

18. The method according to claim 15 wherein the outlet manifold is selected from the group consisting of injection spray nozzles and low-pressure, waterfall-effect manifolds.

19. The method according to claim 15 wherein the system is controlled automatically.

20. The method according to claim 15 wherein the system is controlled manually.

21. The method according to claim 14 wherein the control, water supply, and mixing unit are portable and are adapted to be connected to a distribution manifold on an air handler.

22. The method according to claim 19 wherein the system is controlled so that operation of the system beings after a predetermined number of on-off cycles of the air handling system.

23. The method according to claim 12 wherein the intake manifold has three outlets and there are three flow control devices.
